(19) United States
(12) Patent Application Publication
(10) Pub. No.: US 2015/0292543 A1
(43) Pub. Date: Oct. 15, 2015

(54) FIXING ARRANGEMENT COMPRISING BIFUNCTIONAL SCREW

(71) Applicant: UIP GMBH & CO. KG, Mainaschaff (DE)

(72) Inventor: Harald Gottlich, Wedemark (DE)

(73) Assignee: UIP GmbH & Co. KG, Wedemark (DE)

(21) Appl. No.: 14/351,578

(22) PCT Filed: Oct. 15, 2012
(86) PCT No.: PCT/DE2012/000995

§ 371 Date: Apr. 14, 2014

(30) Foreign Application Priority Data
Oct. 13, 2011 (EP) 11008257.5

(51) Int. Cl. F16B 39/02; F16B 35/00

(52) U.S. Cl. CPC F16B 39/021; F16B 35/00

(57) ABSTRACT

The invention relates to fixing arrangement (10) comprising a bifunctional screw (12). The bifunctional screw (12) is screwed directly into a bore (14) which has been previously provided with or without a curable compound and which is introduced into a solid anchoring base (16). The bifunctional screw (12) has a screw head (18) with a tool application element, a substantially cylindrical shaft (20), preferably a tip (22) which is tapered in a truncated cone-like manner or a truncated pyramid-like manner, and at least two, preferably three thread pitches (24, 26, 28) which are formed parallel to one another and which extend in a helical manner at least partly along the length of the shaft (20). The diameter of the bore (14) without the curable compound is smaller than the diameter of the bore (14) with the curable compound. In both cases, however, the bore (14) is such that all of the thread pitches (24, 26, 28) of the bifunctional screw (12) cut into the anchoring base (16).

The invention concerns a fixing arrangement comprising a bifunctional screw.

Heavily loaded fastenings with screws in concrete, masonry, or stone of the most diverse configurations are generally known. These screws involve purely mechanical connections with a form fitting. Furthermore, compound anchors are known in which a metal rod, preferably with a thread or threadlike embossing, are secured in concrete, masonry or stone by means of a curable compound. The metal component of this connection has no contact with the anchoring base in this case.

Starting from this prior art, the problem of the invention is to indicate two fixing arrangements in which only one kind of screw is used, or to indicate a fixing arrangement in which a bifunctional screw is used.

This problem is solved by a fixing arrangement with a bifunctional screw, wherein the bifunctional screw is screwed directly into a bore which has been previously provided with or without a curable compound and which is introduced into a solid anchoring base, wherein the bifunctional screw has a screw head with a tool application element, a substantially cylindrical shaft, preferably a tip which is tapered in a truncated cone-like manner or a truncated pyramid-like manner, and at least two, preferably three thread pitches which are formed parallel to one another and which extend in a helical manner at least partly along the length of the shaft, and wherein the diameter of the bore without the curable compound is smaller than the diameter of the bore with the curable compound, while in both cases the bore is such that all of the thread pitches of the bifunctional screw cut into the wall of the bore or the anchoring base.

Such a bifunctional screw is especially well suited to being anchored in an anchoring base in a bonded manner thanks to a curable compound, as well as in a force-locking or form-fitting manner or only a force-locking or form-fitting manner. According to the invention, the different diameters of the bores are also important.

The bifunctional screw enables an optimal fixing arrangement either with or without curable compound.

It can be advantageous for the thread pitches to have an outer diameter of different size or preferably an outer diameter of the same size. The outer diameter of a thread pitch is measured across the thread crest. Each thread pitch has a constant outer diameter along the length of the shaft. Preferably, each thread pitch is formed as a tapering thread with a blunt tip.

It can be expedient for the thread pitches to all have different flank angles or preferably the same flank angle.

It can be advantageous for the thread pitches to be spaced uniformly apart from each other and preferably to start at a common circumferential line of the shaft.

Advantageously, the outer diameters of the thread pitches are dimensioned so that when screwed in they at least partly dig into and furrow the wall of the bore.

It can be advantageous in the case of a bore without curable compound for 2/8 to ⅞, preferably 4/8 to ⅞ of the height of a thread pitch, measured at right angle starting from the surface of the shaft to the crest of the respective thread pitch, to dig into and furrow the wall of the bore. It can be advantageous in the case of a bore with curable compound for ⅛ to 6/8, preferably 1/8 to 4/8 of the height of a thread pitch, measured at right angle starting from the surface of the shaft to the crest of the respective thread pitch, to dig into and furrow the wall of the bore.

Thus in both cases an annular gap remains between the wall of the borehole and the bifunctional screw, which is filled at least partly, and preferably entirely, with the curable compound, with drilling dust produced during the screwing of the bifunctional screw into the borehole, or with a mixture of the two aforementioned materials. However, a normal installation calls for a hole free from drilling dust. The presence of drilling dust or a mixture of drilling dust and the curable compound has scant influence on the properties of the connection.

Concrete has proven to be an especially suitable anchoring base. The term “firm anchoring base”, however, is taken in a broad sense. Besides the preferred concrete or even aerated concrete it also includes natural or artificial stone, rock, masonry or the like, but also for example crumbly masonry material, soft brick or another soft stone, Wood can also form a firm anchoring base.

It can be expedient for the curable compound to be mortar or a chemically hardening adhesive, preferably a methyl methacrylate adhesive or a polyester adhesive or most preferably an epoxy resin adhesive,

It can be advantageous for the diameter of the bore without curable compound to be 1/10 to 4/10, preferably 1/10 to 2/10 smaller than the diameter of the bore with curable compound.

The invention is explained below by means of a sample embodiment, which is depicted in the drawing. There is shown here

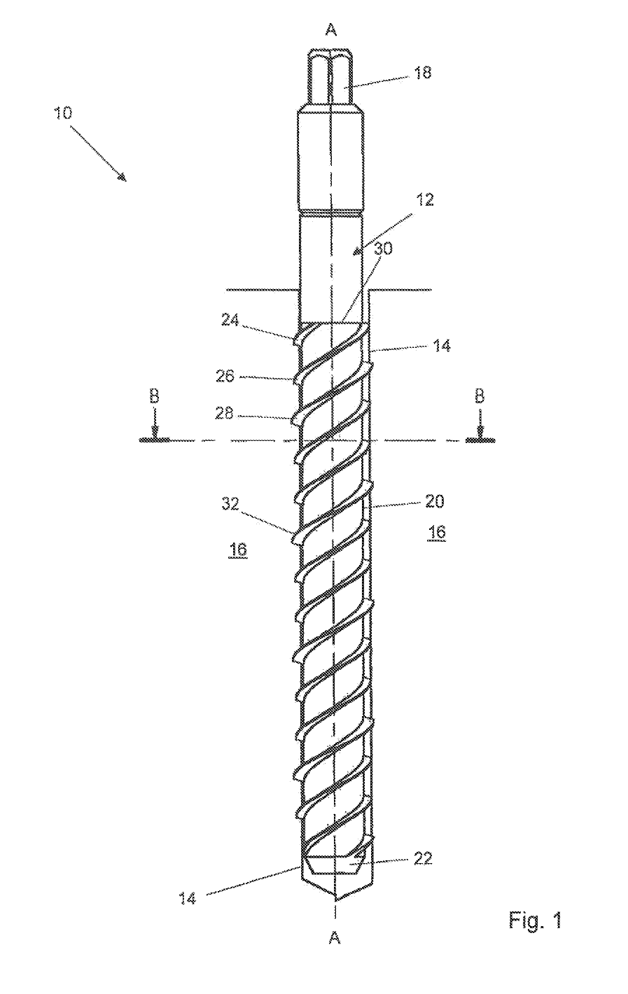

FIG. 1, two fixing arrangements according to the invention with a bifunctional screw in side view, and

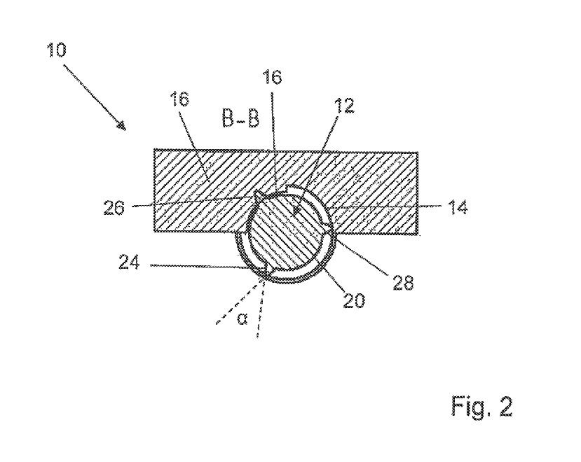

FIG. 2, two fixing arrangements according to the invention with a bifunctional screw according to FIG. 1 in partial view in a cross sectional plane (B).

Two fixing arrangements 10 are illustrated in FIG. 1.

The side arranged on the left of the parting plane A-A refers to a purely mechanical fixing arrangement 10, in which the bifunctional screw 12 is screwed directly and without anchor into a bore 14 not provided with curable compound that has been made in a firm anchoring base 16.

The side arranged to the right of the parting plane A-A pertains to a fixing arrangement 10 in which the bifunctional screw is screwed directly into a bore 14 previously provided with curable compound that has been made in a firm anchoring base 16.

FIG. 1 makes it clear that only one type of the screw 12 according to the invention is being used in two different fixing arrangements 10. Therefore, in this case one can speak of a bifunctional screw.

The bifunctional screw 12 has a screw head 18 with a tool application element, a substantially cylindrical shaft 20, preferably a tip 22 which is tapered in a truncated cone-like manner or a truncated pyramid-like manner, and at least two, preferably three thread pitches 24, 26, 28 which are formed parallel to one another and which extend in a helical manner at least partly along the length of the shaft 20.

According to the invention, the diameter of the bore 14 without the curable compound is smaller than the diameter of the bore 14 with the curable compound. This is clearly evident in FIG. 1.

However, in both cases, i.e., both on the left and the right side of the palling plane A-A, the bore 14 is such that all of the thread pitches 24, 26, 28 of the bifunctional screw 12 cut into the anchoring base 16 or into the wall of the bore 14.

The bifunctional screw 12 shown in FIG. 1 has a tip 22 slightly tapered in a truncated cone-like manner at a front end of the screw and a screw head 18 at a rear end of the screw. The tip 22 tapering in truncated cone-like manner facilitates the introducing of the bifunctional screw 12 into the bore 14 of the anchoring base 16 and allows the thread pitches to cut in with slight torque. In the sample embodiment shown, the screw head 18 is shown in a sample tool application element; this head shape is advantageous, but not compulsory.

The bifunctional screw 12 depicted here has three thread pitches 24, 26, 28, which extend in helical manner along the length of the shaft 20. The thread pitches 24, 26, 28 have the same outer diameter, measured across the crest 32, and the same flank angle α, as well as the same lead.

It is furthermore evident in FIG. 1 that, in the case of the bore 14 without curable compound shown on the left side of the parting plane A-A, 4/8 to ⅞ of the height of a thread pitch 24, 26, 28, measured at right angle starting from the surface of the shaft 20 to the crest 32 of the respective thread pitch 24, 26, 28, digs into and furrows the wall of the bore 14.

It is also evident in FIG. 1 that, in the case of the bore 14 with curable compound shown on the right side of the parting plane A-A, ⅛ to 4/8 of the height of a thread pitch 24, 26, 28, measured at right angle starting from the surface of the shaft 20 to the crest 32 of the respective thread pitch 24, 26, 28, digs into and furrows the wall of the bore 14.

FIG. 2 shows the two fixing arrangements according to the invention with bifunctional screw according to FIG. 1 in partial view in a cross section plane (B). The thread pitches 24, 26, 28 are advantageously spaced uniformly apart from each other and start at a common circumferential line 30 of the shaft 20. In other respects, to avoid repetition, refer to the description per FIG. 1, where the same parts have the same reference numbers.

Of course, the invention is not confined to the sample embodiment, but rather is quite variable within the scope of the disclosure.

### LIST OF REFERENCE SYMBOLS

(part of the specification)
10 fixing arrangement
12 bifunctional screw
14 bore
16 anchoring base
18 screw head
20 shaft
22 tip
24 1st thread pitch
26 2nd thread pitch
28 3rd thread pitch
30 circumferential line
32 crest
α thread pitch flank angle

1. Fixing arrangement with a bifunctional screw, wherein the bifunctional screw is screwed directly into a bore which has been previously provided with or without a curable compound and which is introduced into a solid anchoring base, wherein the bifunctional screw has a screw head with a tool application element, a substantially cylindrical shaft, preferably a tip which is tapered in a truncated cone-like manner or a truncated pyramid-like manner, and at least two, preferably three thread pitches which are formed parallel to one another and which extend in a helical manner at least partly along the length of the shaft, and wherein the diameter of the bore without the curable compound is smaller than the diameter of the bore with the curable compound, while in both cases the bore is such that all of the thread pitches of the bifunctional screw cut into the anchoring base.

2. Fixing arrangement according to claim 1, wherein the thread pitches have an outer diameter of different size or preferably an outer diameter of the same size.

3. Fixing arrangement according to claim 1, wherein the thread pitches have different flank angles (α) or preferably the same flank angle (α).

4. Fixing arrangement according to claim 1, wherein the thread pitches are spaced uniformly apart from each other and preferably start at a common circumferential line of the shaft.

5. Fixing arrangement according to claim 1, wherein the outer diameters of the thread pitches are dimensioned so that they when screwed in at least partly dig into and furrow the wall of the bore.

6. Fixing arrangement according to claim 5, wherein, in the case of a bore without curable compound, 2/8 to ⅞, preferably 4/8 to ⅞ of the height of a thread pitch, measured at right angle starting from the surface of the shaft to the crest of the respective thread pitch, digs into and furrows the wall of the bore.

7. Fixing arrangement according to claim 5, wherein, in the case of a bore with curable compound, ⅛ to 6/8, preferably ⅛ to 4/8 of the height of a thread pitch, measured at right angle starting from the surface of the shaft to the crest of the respective thread pitch, digs into and furrows the wall of the bore.

8. Fixing arrangement according to claim 1, wherein the anchoring base is concrete, masonry, aerated concrete, stone or wood.

9. Fixing arrangement according to claim 1, wherein the curable compound is mortar or a chemically hardening adhesive, preferably a methyl methacrylate adhesive or a polyester adhesive or most preferably an epoxy resin adhesive.

10. Fixing arrangement according to claim 1, wherein the diameter of the bore without curable compound is 1/10 to 4/10, preferably 1/10 to 2/10 smaller than the diameter of the bore with curable compound.

11. A bifunctional screw wherein the bifunctional screw is adapted to be screwed directly into a bore in a solid anchoring base which has been previously provided with or without a curable compound, wherein the bifunctional screw has a screw head with a tool application element, a substantially cylindrical shaft, preferably a tip which is tapered in a truncated cone-like manner or a truncated pyramid-like manner, and at least two thread pitches which are formed parallel to one another and which extend in a helical manner at least partly along the length of the shaft, and wherein the bifunctional screw is adapted to be screwed into a smaller diameter of the bore without the curable compound than the diameter of the bore with the curable compound, while in both cases the bifunctional screw's thread pitches cut into the anchoring base.

12. The bifunctional screw according to claim 11, wherein the thread pitches have an outer diameter of different size or preferably an outer diameter of the same size.

13. The bifunctional screw according to claim 11, wherein the thread pitches have different flank angles (α) or preferably the same flank angle (α).

14. The bifunctional screw according to claim 11, wherein the thread pitches are spaced uniformly apart from each other and preferably start at a common circumferential line of the shaft.

15. The bifunctional screw according to claim 11, wherein the outer diameters of the thread pitches are dimensioned so that they when screwed in at least partly dig into and furrow the wall of the bore.

16. The bifunctional screw according to claim 15, wherein, in the case of a bore without curable compound, 2/8 to ⅞, preferably 4/8 to ⅞ of the height of a thread pitch, measured at right angle starting from the surface of the shaft to the crest of the respective thread pitch, the bifunctional screw is adapted to dig into and furrow the wall of the bore.

17. The bifunctional screw according to claim 15, wherein, in the case of a bore with curable compound, ⅛ to 6/8, preferably ⅛ to 4/8 of the height of a thread pitch, measured at right angle starting from the surface of the shaft to the crest of the respective thread pitch, the bifunctional screw is adapted to dig into and furrow the wall of the bore.

18. The bifunctional screw according to claim 11, wherein the bifunctional screw is adapted to screw into an anchoring base of concrete, masonry, aerated concrete, stone or wood.

19. The bifunctional screw according to claim 11, wherein the bifunctional screw is adapted to be used with a curable compound selected from one of a group of curable compounds consisting of mortar, a chemically hardening adhesive, a methyl methacrylate adhesive, a polyester adhesive, and epoxy resin adhesive.

20. The bifunctional screw according to claim 11, wherein the bifunctional screw is adapted to interlace with a bore of a diameter without curable compound which is 1/10 to 4/10, preferably 1/10 to 2/10 smaller than the diameter of the bore with curable compound.
